(19) United States
(12) Patent Application Publication
(10) Pub. No.: US 2024/0288706 A1
(43) Pub. Date: Aug. 29, 2024

(54) SYSTEMS AND METHODS FOR PRECISELY ASSEMBLING OPTICS

(71) Applicant: Panasonic Intellectual Property Management Co., Ltd., Osaka (JP)

(72) Inventors: Fangqin Li, Acton, MA (US); Xinbing Liu, Acton, MA (US); Carlton Brule, Boston, MA (US); Liang Chang, Boxborough, MA (US); Riccardo Leto, Arlington, MA (US)

(21) Appl. No.: 18/113,694

(22) Filed: Feb. 24, 2023

(51) Int. Cl. G02B 27/62

(52) U.S. Cl. CPC G02B 27/62

(57) ABSTRACT

A method of applying a precompensation for shrinkage during a real-time assembly of an optical component. Prior to the real-time assembly, (a) the optical component is aligned to obtain a reference position (h_{ref}); (b) pre-assembly laser beam data (reference beam size (ω_{ref}), reference beam position (p_{ref}), beam size (ω), and beam position (p)) is plotted; (c) the optical component is aligned in one or more positions (h) and repeating step (b) for each position (h); (d) adhesive is applied to the base; (e) curing the adhesive; (f) test laser beam data (beam size (ω_{cure}) and beam position (p_{cure})) is plotted; (g) position of the optical component (h_{cure}) is determined based on pre-assembly and test laser beam data; (h) a precompensation value (|h_{ref}−h_{cure}|) is calculated; and (i) the optical component is aligned at a height (|h_{ref}−h_{cure}|+h_{ref}) before performing step (e) during the real-time assembly.

### FIELD OF THE INVENTION

The present invention relates to optical systems and assemblies, and more specifically to systems and methods for precisely assembling optics.

### BACKGROUND OF THE INVENTION

Adhesive bonding technology is conventionally used to assemble optical components. Cured adhesive material usually has high mechanical strength, high thermal stability, and resistance to humidity and chemicals. During the curing process, adhesive materials, such as thermally cured and UV-cured adhesives, suffer some volume shrinkage, e.g., polymerization shrinkage. The shrinkage property of adhesive materials can result in undesirable misalignment of the optics or optical component to be assembled. To mitigate misalignment during the curing process, reducing the amount of adhesive is helpful, but the bonding strength of the adhesive material may also be weakened. Alternatively, an adhesive material with low shrinkage may be selected to mitigate misalignment during the curing process. However, misalignment may not be completely prevented by using low-shrinkage adhesive or a small amount of adhesive.

Conventionally, to select an adhesive with low shrinkage, dilatometer methods (volumetric and/or non-volumetric) can be performed to measure or determine characteristics of adhesive shrinkage, particularly with respect to bulk samples of adhesive material. Volumetric dilatometric methods include, for example, capillary-type dilatometer, gravimetric method and plunger-type dilatometer. Volumetric dilatometric methods include direct measurement of adhesive volume change (shrinkage is derived from volume variation) whereas non-volumetric dilatometric methods use a contacting or non-contacting transducer to measure the linear shrinkage and recalculate the volumetric shrinkage (e.g. rheometer and thermal mechanical analyzer (TMA)). Methods for measuring shrinkage of smaller amounts of adhesive material are known. See e.g., A. J. Hudson's group (Journal of Electronic Packaging, Vol. 124, 352-354 (2002) (describing an optical method to measure volume shrinkage of UV adhesive using the so-called spot-curing method by illuminating controlled exposure of UV-light with known distribution of wavelength to the sample, and did drop shape analysis, and claimed that reproducible values for the volumetric shrinkage was achieved). Other studies related to measurement of adhesive shrinking include: Fraunhofer Institute (Optik&Photonik April 2017, P41-43) (describing a setup to measure the linear shrinkage of UV adhesive using laser distance sensor under real conditions in micro-optical systems, and results of their study demonstrated independence of the absolute shrinkage on the intensity of UV light and dependence of the shrinkage on the thickness of the adhesive); Tobias Müller et. al. (IPAS 2014, IFIP AICT 435, pp. 1-7, 2014) (emphasizing the importance of precise volumetric dosing of UV adhesive and describing a simple optical setup to measure the UV adhesive shrinkage which contributes to angular misalignment of optics using a position sensitive device (PSD), so that the compensation of shrinkage may be predicted by calculating the offset values based on the measured shrinkage).

To mitigate or prevent misalignment during the curing process, precompensation for the adhesive shrinkage may be performed before the curing process. The precompensation of adhesive shrinkage is typically determined, however, by calculating the offset values based on the shrinkage data of the adhesive material, which are measured with a specific setup for the limited purpose of measuring said values. Thus, the measurements are conventionally not obtained in-situ, such that any prediction errors on the precompensation measurements can materially impact (in time, expense, etc.) real time use or applications of the adhesive material.

Thus, systems and methods of precisely assembling optics or optical components by determining precompensation of adhesive shrinkage are desired for improving the alignment of optical components during the curing process of adhesive materials, particularly as compared to utilizing standard methods of measuring or predicting precompensation for the adhesive shrinkage.

### SUMMARY OF THE INVENTION

Aspects of the present invention are directed to optical systems and assemblies. More particularly, the present invention relates to systems and methods for precisely assembling optics or optical components by determining and applying precompensation of adhesive shrinkage.

In accordance with one aspect of the present invention, a method of applying a precompensation for adhesive shrinkage during a real-time assembly of an optical component is disclosed. The optical component is positionable relative to a base by an alignment stage and after or away from a laser source configured for providing a laser beam. Specifically, the method comprises the steps of: (a) aligning the optical component relative to a base based on a reference beam size (ω_{ref}) and a reference beam position (p_{ref}) to obtain a reference position (h_{ref}), which is determined by the alignment stage; (b) plotting pre-assembly laser beam data reflected or transmitted by the optical component; (c) aligning the optical component relative to the base in one or more misalignment positions (h) and repeating step (b) for each misalignment position (h), which is determined by the alignment stage, wherein at the respective one or more misalignment positions (h), the pre-assembly laser beam data comprises a respective beam size (ω) and a respective beam position (p); and wherein steps (a) to (c) occur prior to the real-time assembly of the optical component; (d) during a test event and the real-time assembly, applying an amount of curable adhesive to the base; (e) during the test event and the real-time assembly, curing the adhesive; (f) plotting test laser beam data reflected or transmitted by the optical component during the test event, wherein the test laser beam data comprises a beam size (ω_{cure}) and a beam position (p_{cure}); (g) determining a position of the optical component (h_{cure}) based on the pre-assembly laser beam data and the test laser beam data; (h) calculating a precompensation value (δ=|h_{ref}−h_{cure}|), thereby estimating a linear shrinkage of the cured adhesive; and (i) aligning the optical component relative to the base at a height (h=δ+h_{ref}=|h_{ref}−h_{cure}|+h_{ref}) before performing step (e) during the real-time assembly, thereby minimizing a misalignment of the optical component relative to the base during the real-time assembly.

In accordance with another aspect of the invention, a system for assembling optical components is disclosed. The system includes an optical assembly comprising: a laser source for providing a laser beam, a base, a gripper mounted on an alignment stage, the alignment stage being connected to a controller, an optical component held by the gripper and positionable adjacent the base via the alignment stage, a beam profiler for measuring laser beam data at a position (h) of the optical component relative to the base, wherein the position (h) is measured by the alignment stage, the laser beam data comprises a laser beam size (w) and a laser beam position (p), and wherein the laser source, the optical component, and the beam profiler together define a laser beam path. The system also includes an adhesive assembly comprising: a curable adhesive, and an adhesive dispenser for applying the curable adhesive between an edge portion of the optical element and the base.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 depicts a schematic layout of an exemplary system for assembling optical components;

FIG. 2 depicts an exemplary method of applying a precompensation for adhesive shrinkage during a real-time assembly of an optical component;

FIG. 3A depicts a schematic layout of another exemplary system for assembling optical components in accordance with an embodiment of the invention;

FIG. 3B depicts exemplary steps of the method of FIG. 2, in accordance with an embodiment of the invention;

FIG. 4A depicts a schematic layout of yet another exemplary system for assembling optical components in accordance with an embodiment of the invention;

FIG. 4B depicts exemplary steps of the method of FIG. 2, in accordance with an embodiment of the invention;

FIG. 5A depicts a schematic layout of still another exemplary system for assembling optical components in accordance with an embodiment of the invention; and

FIG. 5B depicts exemplary steps of the method of FIG. 2, in accordance with an embodiment of the invention.

### DETAILED DESCRIPTION OF INVENTION

Aspects of the invention are described herein with reference to a system for assembling optical components, the system comprising an optical assembly and an adhesive assembly. However, it will be understood by one of ordinary skill in the art that the exemplary components of the optical assembly and adhesive assembly, as described herein, are not intended to be limiting or exhaustive, but additional or optional elements of the system may be incorporated or removed to achieve a desired result. Likewise, aspects of the invention are described herein with reference to methods for applying a precompensation for adhesive shrinkage during a real-time assembly of an optical component. However, it will be understood by one of ordinary skill in the art that neither the exemplary methods nor the steps described therein are limited to assembly of a particular optical component, and may be applicable to other known optical components or similar devices. In particular, the systems and methods described herein are applicable to the assembly of optical components, wherein their misalignment can be affected by the shrinkage of adhesive and/or their misalignment can be assessed based on monitoring certain characteristics of a laser beam (e.g. beam size, beam position, etc.)

The terms “optical component” and “optics” as described herein and throughout the specification may encompass optical components (transmissive or reflective) for use in a variety of applications, including but not limited to lenses, filters, windows, optical flats, prisms, polarizers, beamsplitters, wave plates, fiber optics, UV & IR Optics, mirrors, and retroreflectors. Still further, as used herein and throughout the specification, terms referring to a direction, or a position relative to the orientation of the laser beam path (discussed below), such as but not limited to “vertical,” “horizontal,” “lateral,” “upper,” “lower,” “above,” or “below,” refer to directions and relative positions with respect to orientation of the laser beam path and/or optical component for assembly.

Additionally, various forms and embodiments of the invention are illustrated in the figures. It will be appreciated that the combination and arrangement of some or all features of any of the embodiments with other embodiments is specifically contemplated herein. Accordingly, this detailed disclosure expressly includes the specific embodiments illustrated herein, combinations and sub-combinations of features of the illustrated embodiments, and variations of the illustrated embodiments.

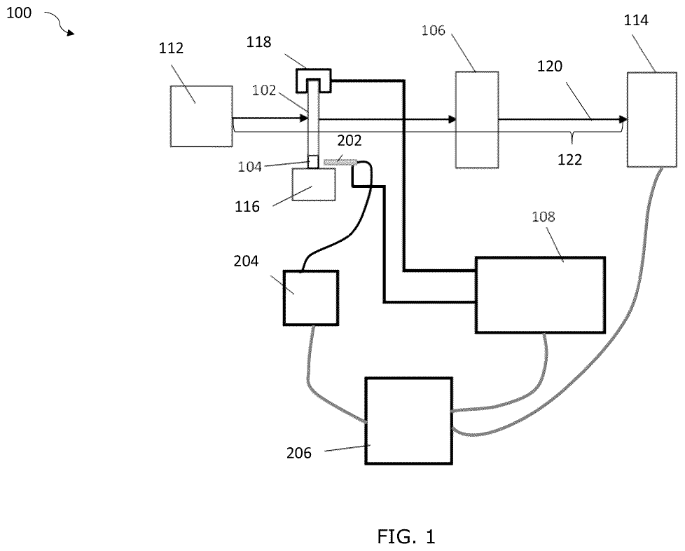

Referring now to FIG. 1, an exemplary system 100 for assembling optical components is disclosed. In general, the system 100 includes an optical assembly and an adhesive assembly. In an exemplary embodiment, the optical assembly includes a laser source 112 for providing a laser beam 120. The optical assembly 100 also includes a base, such as base plate 116, and an optical component 102 is positionable adjacent the base plate 116. In a non-limiting example, and as shown in FIG. 1, the optical component 102 to be assembled in a real-time assembly is positionable on or above the base plate 116 and after or away from laser source 112. As used herein and throughout the specification, relative terms such as “away from”, “before”, “after”, “above”, “below”, and like terms should be construed to refer to the position or orientation as then described or as shown in the drawing figure under discussion. These relative terms are for convenience of description and normally are not intended to require a particular orientation or location.

In an exemplary embodiment, the optical assembly 100 includes a gripper 118 (discussed below) mounted on an alignment stage, such as alignment stage 118 (discussed below), which is connected to a controller, such as externa device 206 (e.g. a computer). In this way, the controller 206 controls at least the operation of the alignment stage 108. In this configuration, the optical component 102 is held by the gripper 118 and positionable adjacent the base 116 via the alignment stage 108. The optical assembly 100 further comprises a beam profiler 114 for measuring laser beam data. In a non-limiting example, the laser beam data is related to the laser beam 120 reflected or transmitted by the optical component 102. In an exemplary embodiment, the beam profiler 114 measures laser beam data at a position (h) of the optical component 102 relative to the base plate 116, which is determined by the alignment stage 108, The laser beam data comprises one or more of a position (h) of the optical component 102 relative to the base plate 116 as detected and measured by the alignment stage 108, a laser beam size (ω) of laser beam 120 as detected and measured by the beam profiler 114, and a laser beam position (p) of laser beam 120 as detected and measured by the beam profiler 114. In an exemplary embodiment, and as shown in FIG. 1, the laser source 112, the optical component 102, and the beam profiler 114 are positionable relative to each other, such that together they define a laser beam path 122 along which the laser beam 120 is reflected or transmitted by the optical component 102.

In an exemplary embodiment, the adhesive assembly includes a curable adhesive 104. In one non-limiting example, the curable adhesive 104 is curable by a radiation source (e.g. ultraviolet light). However, one skilled in the art would understand that curable adhesive 104 may comprise other types of curable adhesives and epoxy, including but not limited to thermally cured adhesives.

The curable adhesive 104 is configured to be applied to the base plate 116. In a non-limiting example, the curable adhesive 104 is applied to the base plate 116 via a syringe 202 positionable adjacent the optical component 102. The syringe 202 is connected to an adhesive dispenser 204 (e.g. via one or more tubes) configured to store or contain curable adhesive 104. In a non-limiting example, the syringe 202 comprises an opaque tube. The adhesive dispenser 204 is further connected to a controller or an external device 206 (e.g. a computer), which is configured for controlling operation of one or more components of system 100. In an exemplary embodiment, external device 206 is configured to control a position and amount of curable adhesive 104 to be applied by syringe 202 and supplied from the adhesive dispenser 204.

As will be explained further below, adjusting the alignment of the optical component 102 may be required during at least the real-time assembly of the optical component 102. In an exemplary embodiment, the optical component 102 can be precisely aligned linearly along three orthogonal directions. Additionally, or optionally, the optical component 102 can be precisely aligned via a motor-driven 3D alignment stage, such as alignment stage 108. The alignment stage 108 may be connected to the external device 206 (e.g. a computer) configured for controlling at least operation of the alignment stage 108. Additionally, to facilitate the alignment of the optical component 102 (e.g. alignment relative to the base plate 116), the optical component 102 is held or gripped by a gripper 118. In a non-limiting example, the gripper 118 is mounted on the alignment stage 108 with high resolution (e.g. of <0.1 μm). Additionally, or optionally, if tilt adjustment of the optical component 102 is required, the gripper 118 can be mounted to a piezo motor mirror mount (not shown) configured for pitch and yaw adjustment. The mirror mount with the gripper may also be mounted on the alignment stage 108 depending on the actual requirements of the assembly of optical component 102. The mirror mount is further configured to be connected to the external device 206 and mounted on to the alignment stage 108. Additionally, or optionally, syringe 202 may also be fixed on the alignment stage 108.

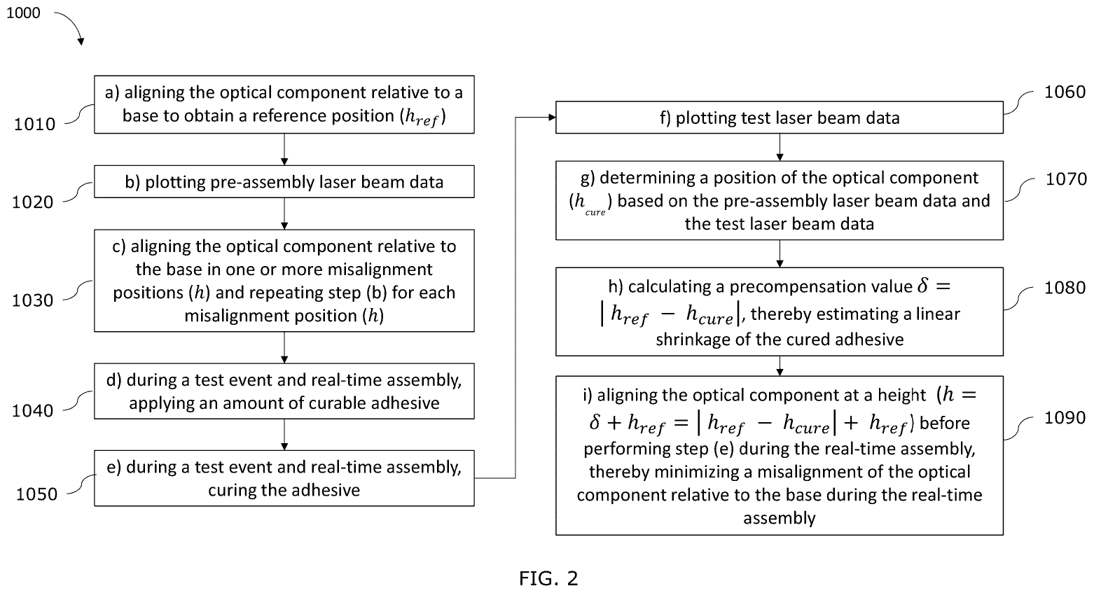

Referring now to FIGS. 1 and 2, a method 1000 of applying a precompensation for adhesive shrinkage during a real-time assembly of an optical component is provided. The method 1000 is described herein with reference to at least components of system 100, such as the optical component 102, the base, such as base plate 116, and adhesive 104. In particular, the optical component 102 is positionable relative to a base by the alignment stage 108 and away from the laser source 112, the laser source 112 being configured for providing a laser beam 120. The method 1000 includes one or more steps, including the following:
Step 1010—(a) aligning the optical component relative to a base based on a reference beam size (ω_{ref}) and a reference beam position (p_{ref}) to obtain a reference position (h_{ref}), which is determined by the alignment stage 108;
Step 1020—(b) plotting pre-assembly laser beam data reflected or transmitted by the optical component;
Step 1030—(c) aligning the optical component relative to the base in one or more misalignment positions (h) and repeating step (b) for each misalignment position (h), which is determined by the alignment stage 108;
Step 1040—(d) during a test event and the real-time assembly, applying an amount of curable adhesive between an edge portion of the optical component and the base;
Step 1050—(e) during the test event and the real-time assembly, curing the adhesive;
Step 1060—(f) plotting test laser beam data reflected or transmitted by the optical component during the test event;
Step 1070—(g) determining a position of the optical component (h_{cure}) based on the pre-assembly laser beam data and the test laser beam data;
Step 1080—(h) calculating a precompensation value (δ=|h_{ref}−h_{cure}|), thereby estimating a linear shrinkage of the cured adhesive; and
Step 1090—(i) aligning the optical component relative to the base at a height (h=δ+h_{ref}=|h_{ref}−h_{cure}|+h_{ref}) before performing step (e) during the real-time assembly, thereby minimizing a misalignment of the optical component relative to the base during the real-time assembly.

In an exemplary embodiment, the optical component 102 is a lens, such as a collimation lens. Additionally, or optionally, the pre-assembly laser beam data is measured by a beam profiler, such as beam profiler 114 (FIG. 1). In an exemplary embodiment, the beam profiler 114 is positionable adjacent the optical component 102. In this configuration, at least the laser source 104, the optical component 102, and the beam profiler 114 together define a laser beam path 122. Optionally, the laser beam path 122 is defined by at least the laser source 104, the optical component 102, the beam profiler 114, and an imaging optics 106. In this configuration, the imaging optics 106 is positionable between the beam profiler 114 and the optical component 102. Additionally, or optionally, a beam attenuator (not shown) may be incorporated along the laser beam path 122. In particular, the beam attenuator, which is configured for attenuating an intensity of the laser beam 120 from the laser source 112, is positionable adjacent the beam profiler 114. Additional details of method 1000 are discussed below.

In step 1010, the optical component 102 is aligned. In an exemplary embodiment, the optical component 102 is aligned relative to a base, such as base plate 116, based on a reference beam size (ω_{ref}) and a reference beam position (p_{ref}) to obtain a reference position (h_{ref}). The reference position (h_{ref}) is determined by the alignment stage 108. Additionally, or optionally, the optical component 102 can be precisely aligned linearly along three orthogonal directions. In one non-limiting example, the alignment may be facilitated by a motor-driven 3D alignment stage, such as alignment stage 108 as described above.

Step 1020 includes plotting pre-assembly laser beam data reflected or transmitted by the optical component. In an exemplary embodiment, pre-assembly laser beam data is related to characteristics of a laser beam 120 reflected or transmitted by the optical component 102. In one non-limiting example, the pre-assembly laser beam data has the optical component 102 is at the reference position (h_{ref}) after a reference beam size (ω_{ref}) and a reference beam position (p_{ref}) is determined. Accordingly, the ω_{ref}/p_{ref} is the optimized beam size/beam position required in real-time assembly by aligning the optical component 102. As used herein, the term “optimized” means, for example, that the reference beam size (ω_{ref}) includes the minimum value by aligning optics (e.g. imaging optics 106, 206, 306) and the reference beam position (p_{ref}) is coincident with some predetermine location or reference. The reference position (h_{ref}), reference beam size (ω_{ref}), and a reference beam position (p_{ref}) may correspond to the desired parameters for real-time assembly of the optical component 102.

Step 1030 comprises aligning the optical component relative to the base in one or more misalignment positions (h). The position (h) is determined by the alignment stage 108. In an exemplary embodiment, the optical component 102 is aligned relative to the base 116 in one or more misalignment positions (h) and step 1020 (i.e. step (b)) is repeated for each misalignment position (h). As with step 1010, the optical component 102 can be precisely aligned linearly along three orthogonal directions, and the alignment may be facilitated by alignment stage 108. Additionally, step 1020 (i.e. step (b)) is repeated for each misalignment position (h). In an exemplary embodiment, at the respective one or more misalignment positions (h), the pre-assembly laser beam data comprises a respective beam size (ω) and a respective beam position (p), which can be plotted in a chart. Specifically, a chart of a plurality of beam sizes (ω) and beam positions (p) (ω/p) versus the corresponding plurality of positions (h) of the optical component 102 is plotted.

In an exemplary embodiment, steps 1010-1030, i.e. steps (a) to (c), occur prior to the real-time assembly of the optical component 102.

Step 1040 includes applying an amount of curable adhesive and step 1050 includes curing the amount of curable adhesive. In an exemplary embodiment, the curable adhesive is applied during a test event and the real-time assembly. Particularly, curable adhesive 104 is applied to the base 116. Non-limiting examples of curable adhesive 104 comprise adhesive or epoxy material curable by a radiation source (e.g. ultraviolet light) or other known curing means. Additionally, or optionally, step 1040 includes aligning the optical component 102 to a height greater than the reference position (h_{ref}). Additionally, the adhesive 104 is applied when the optical component 102 is positioned at the height greater than the reference position (h_{ref}).

Due to the adhesive shrinkage of the adhesive 104, the lens height or position (h) will change, e.g. decrease. Additionally, or optionally, the optical component 102 may also be tilted. Changes in the height or position (h) of the optical component 102 (e.g. relative to base 116) can result in changes or shifts of measurable beam size (ω) and beam position (p). Thus, to precisely control the position (h) of the optical component 102 after cure of adhesive 104, a change in the alignment of the optical component 102 is required advance of the real-time assembly of the optical component 102, in order to partially or entirely compensate for the estimated misalignment due to adhesive shrinkage.

In step 1060, test laser beam data reflected or transmitted by the optical component is plotted. In an exemplary embodiment, the test laser beam data is collected during the test event. In this way, the laser beam data comprises a beam size (ω_{cure}) and a beam position (p_{cure}). Additionally, or optionally, the test laser beam data is measured by a beam profiler 114. The beam profiler 114 may be disposed adjacent the optical component 102, such that at least the laser source 104, the optical component 102, and the beam profiler 114 together define the laser beam path 122. Specifically, a plurality of beam sizes (ω_{cure}) and beam positions (p_{cure}) (ω_{cure}/p_{cure}) of the optical component 102 is plotted.

Step 1070 comprises determining a position of the optical component (h_{cure}) based on the pre-assembly laser beam data and the test laser beam data. In an exemplary embodiment, a position of the optical component (h_{cure}) relative to the base 116 is determined based on the laser beam data, as plotted in step 1020 (in which the pre-assembly laser beam data comprises reference beam size (ω_{ref}) and reference beam position (p_{ref})) and step 1060 (in which the test laser beam data comprises beam size (ω_{cure}) and beam position (p_{cure})).

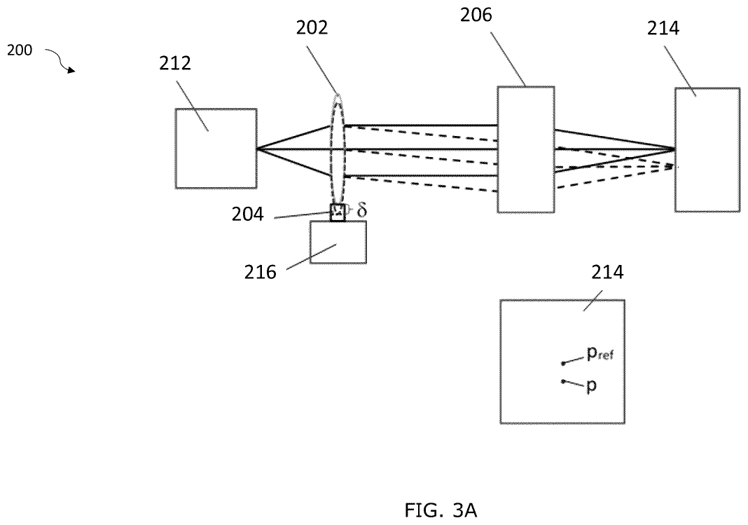

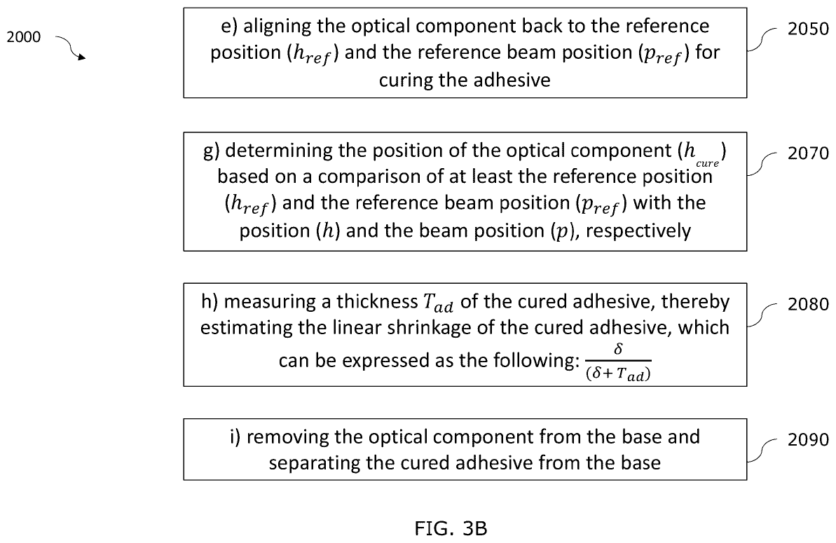

When the position of the optical component 102 (h_{cure}) is determined, step 1080 requires calculating a precompensation value, or a distance change of the optical component 102 relative to the base plate 116 (δ=|h_{ref}−h_{cure}|). In an exemplary embodiment, the precompensation value represents a difference in position of optical component 102 relative to the base plate 116 between the pre-assembly laser beam data and the test laser beam data. Thus, the precompensation value can also be expressed as (δ=|h_{ref}−h_{cure}|) as shown, for example in FIG. 3 (discussed further below), thereby allowing for the estimation of a linear shrinkage of the cured adhesive 104.

In step 1090, the optical component is aligned relative to the base at a height (h=δ+h_{ref}=|h_{ref}−h_{cure}|+h_{ref}) before performing step (e) during the real-time assembly. In an exemplary embodiment, the optical component 102 is placed at a distance or height (e.g. above) relative to base plate 116 before performing step (e) during the real-time assembly, and the distance or height corresponds to the calculated distance (|h_{ref}−h_{cure}|+h_{ref}). After performing step (e) during the real-time assembly, i.e. after the adhesive 104 is cured during the real-time assembly, the optical component 102 is positioned at a distance or height (e.g. above) relative to base plate 116, and the distance or height corresponds to a thickness of the cured adhesive 104.

In this way, a precompensation is applied for adhesive shrinkage during a real-time assembly of the optical component 102, thereby minimizing a misalignment of the optical component 102 relative to the base plate 116 during the real-time assembly of the optical component 102. Therefore, precompensation is applied based on data (e.g. laser beam data) obtained in-situ, such that any prediction errors on the precompensation measurements is minimized or prevented during real time assembly of the optical component 102 or applications of the adhesive material 104. In other words, by providing a method 1000 that can be executed in in-situ, such as at any time when the adhesive shrinkage requires correction, the shrinkage measurement of adhesive 104 is directly correlated with beam size (ω) and beam positions (p) changes, if any, under real-time conditions during the real-time assembly of the optical component 102.

The sequence described above is an exemplary process or method comprising steps that are performed sequentially in the order recited. However, it should be understood from the description herein that one or more steps may be omitted and/or performed out of the described sequence while still achieving the desired result. Further, additional steps may be included within the sequence.

A second embodiment of a system for assembling optical components in accordance with an embodiment of the invention, and a corresponding method of applying a precompensation for adhesive shrinkage during a real-time assembly of an optical component with reference to said system, is disclosed in FIGS. 3A-3B. In an exemplary embodiment, system 200 and method 2000 generally correspond respectively to system 100 and method 1000, as described above and illustrated in FIGS. 1 and 2. However, they differ in some respects.

With reference to FIG. 3A, system 200 includes an optical component 202, laser source 212, beam profiler 214, and base 216, the details of which generally correspond to the details of the optical component 102, laser source 112, beam profiler 114, and base 116, respectively as described above. In an exemplary embodiment, optical component 202 is a collimation lens. Further, system 200 may include imaging optics 206, the details of which generally correspond to the details of the imaging optics 106, as described above. Similarly, with reference to FIG. 3B, method 2000 comprises one or more steps of method 1000 and may be performed sequentially in the order recited. Full description of some of the steps in method 2000, to the extent that they are redundant relative to those of method 1000, are omitted from the following description, but one skilled in the art would understand that incorporation of one or more steps from any one or combination of the described methods throughout the specification, is within the spirit and scope of the invention. For example, it should be understood from the description herein that one or more steps may be omitted and/or performed out of the described sequence while still achieving the desired result. Further, additional steps may be included within the sequence. Additional details of method 2000 are described further below.

Step 2050 generally corresponds to the details of the step 1050. However, step 2050 further comprises aligning the optical component back to the reference position (h_{ref}) and the reference beam position (p_{ref}). In an exemplary embodiment, the optical component 202 is aligned back to the reference position (h_{ref}) and the reference beam position (p_{ref}) for curing of the adhesive 204, the details of which generally correspond to the details of adhesive 104. When the optical component is at the reference position (h_{ref}) and the reference beam position (p_{ref}), the adhesive 204 is cured with the laser source 212. Additionally, or optionally, the adhesive 204 is cured by an external radiation source (not shown). The laser source 212 and/or the external radiation source includes ultraviolet (UV) light.

In addition, step 2070 generally correspond to the details of the step 1070. However, step 2070 further comprises determining the position of the optical component (h_{cure}) based on a comparison of at least the reference position (h_{ref}) and the reference beam position (p_{ref}) with the position (h) and the beam position (p), respectively.

Still further, step 2090 generally corresponds to the details of the step 1090. However, step 2090 further comprises removing the optical component 202 from the base, such as base plate 216, and separating the cured adhesive 204 from the base plate 216. In an exemplary embodiment, the cured adhesive 204 is removed (e.g. peeled off) carefully from the base plate 216. Relatedly, step 2080, the details of which generally corresponds to the details of the step 1080, further includes measuring a thickness T_{ad} of the cured adhesive 204. In this way, the linear shrinkage of the cured adhesive 204 is measured, which can be expressed by the following:

$$\frac{δ}{( δ + {T}_{a d} )} .$$

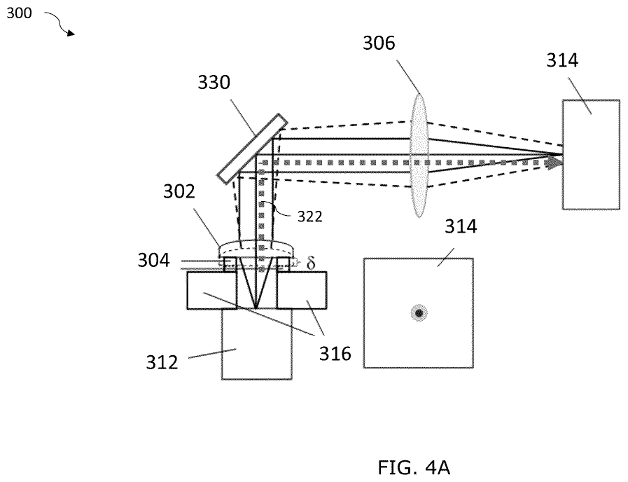

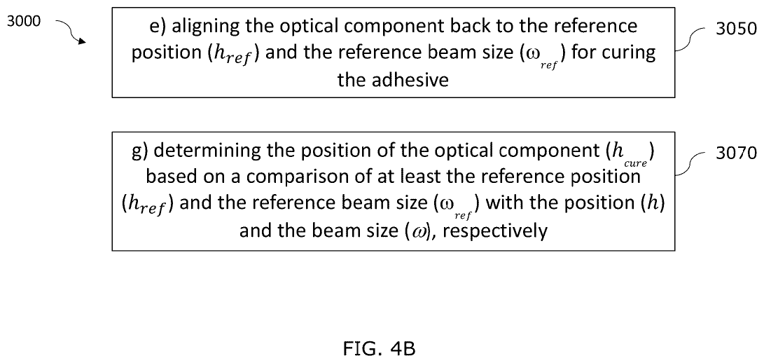

A third embodiment of a system for assembling optical components in accordance with an embodiment of the invention, and a corresponding method of applying a precompensation for adhesive shrinkage during a real-time assembly of an optical component with reference to said system, is disclosed in FIGS. 4A-4B. In an exemplary embodiment, system 300 and method 3000 generally correspond respectively to the system 200 and method 2000, as described above and illustrated in FIGS. 3A-3B. However, they differ in some respects.

With reference to FIG. 4A, system 300 includes an optical component 302, laser source 312, beam profiler 314, and base 316, the details of which generally correspond to the details of the optical component 102, laser source 112, beam profiler 114, and base 116, respectively as described above. In an exemplary embodiment, optical component 302 is a collimation lens. Further, system 300 may include imaging optics 306, the details of which generally correspond to the details of the imaging optics 106, as described above. In an exemplary embodiment, system 300 further comprises a turning mirror 330. The turning mirror 330 is configured to change a direction of the laser beam path 322. In an exemplary embodiment, the laser beam path 322 is defined by at least the laser source 312, turning mirror 330, optionally imaging optics 306, and the beam profiler 314. The turning mirror 330 is positionable above or a distance away from the optical component 302. In this configuration, the laser beam path 322 is changed from a generally upwardly direction to a lateral direction, for example.

Similarly, with reference to FIG. 4B, method 3000 comprises one or more steps of at least method 2000 and may be performed sequentially in the order recited. Full description of some of the steps in method 3000, to the extent that they are redundant relative to those of method 1000 and/or method 2000, are omitted from the following description, but one skilled in the art would understand that incorporation of one or more steps from any one or combination of the described methods throughout the specification, is within the spirit and scope of the invention. Further, it should be understood from the description herein that one or more steps may be omitted and/or performed out of the described sequence while still achieving the desired result. Further, additional steps may be included within the sequence. Additional details of method 3000 are described further below.

Step 3050 generally correspond to the details of the step 2050. However, step 3050 further comprises aligning the optical component back to the reference position (h_{ref}) and the reference beam size (ω_{ref}). In an exemplary embodiment, the optical component 302 is aligned back to the reference position (h_{ref}) and the reference beam size (ω_{ref}) for curing of the adhesive 304, the details of which generally correspond to the details of adhesive 104. When the optical component 302 is at the reference position (h_{ref}) and the reference beam size (ω_{ref}), the adhesive 304 may be cured with the laser source 312. Additionally, or optionally, the adhesive 304 is cured by an external radiation source (not shown). The laser source 312 and/or the external radiation source includes UV light.

In addition, step 3070 generally correspond to the details of the step 2070. However, step 3070 further comprises determining the position of the optical component (h_{cure}) based on a comparison of at least the reference position (h_{ref}) and the reference beam size (ω_{ref}) with the position (h) and the beam size (ω), respectively.

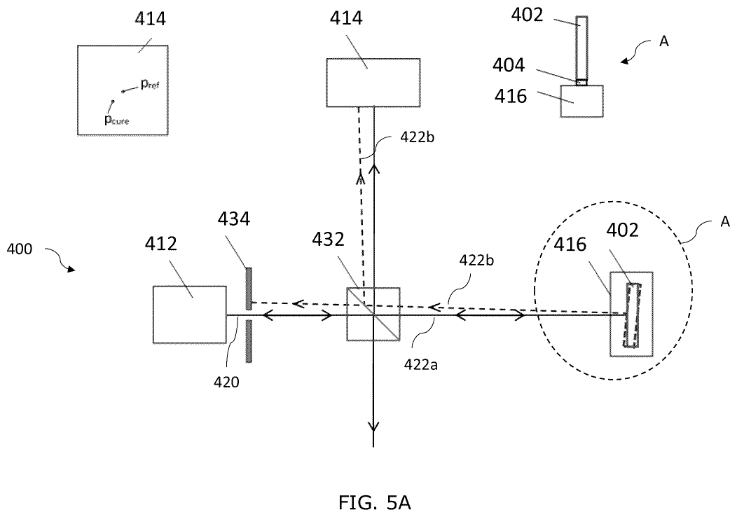

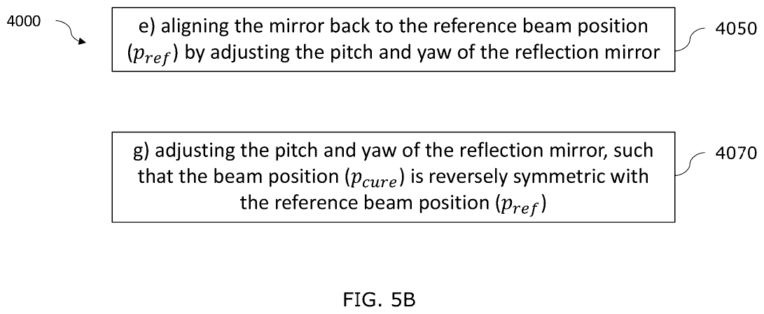

A fourth embodiment of a system for assembling optical components in accordance with an embodiment of the invention, and a corresponding method of applying a precompensation for adhesive shrinkage during a real-time assembly of an optical component with reference to said system, is disclosed in FIGS. 5A-5B. In an exemplary embodiment, system 400 and method 4000 generally correspond respectively to the system 100 and method 1000, as illustrated in FIGS. 1 and 2. However, they differ in some respects.

With reference to FIG. 5A, system 400 includes an optical component 402, laser source 412, beam profiler 414, and base 416, the details of which generally correspond to the details of the optical component 102, laser source 112, beam profiler 114, and base 116, respectively as described above. In an exemplary embodiment, optical component 402 is a mirror, such as reflection mirror 402 disposed on the base 416 and held by a gripper (similar to gripper 118 described above) that is mounted on piezo motor mount. The mirror 402 is configured for yaw and pitch movement. Additionally, or optionally, system 400 includes a beam splitter 432. The beam splitter 432 is configured to split a laser beam 420 (similar to laser beam 120) reflected by the mirror 402 into a first path 422a and a second path 422b. To facilitate this, an aperture 434 is positioned between the laser source 412 and the beam splitter 432. In this configuration, the first path 422a is transmitted through the beam splitter 432 to the aperture 434. On the other hand, the second path 422b is transmitted to the beam profiler 414.

Similarly, with reference to FIG. 5B, method 4000 comprises one or more steps of at least method 1000 and may be performed sequentially in the order recited. Full description of some of the steps in method 4000, to the extent that they are redundant relative to at least method 1000, are omitted from the following description, but one skilled in the art would understand that incorporation of one or more steps from any one or combination of the described methods throughout the specification, is within the spirit and scope of the invention. Further, it should be understood from the description herein that one or more steps may be omitted and/or performed out of the described sequence while still achieving the desired result. Further, additional steps may be included within the sequence. Additional details of method 4000 are described further below.

Step 4050 generally correspond to the details of the step 1050. However, step 4050 further comprises aligning the mirror 402 back to the reference beam position (p_{ref}) by adjusting the pitch and yaw of the reflection mirror 402.

In addition, step 4070 generally correspond to the details of the step 1070. However, step 4070 comprises adjusting the pitch and yaw of the reflection mirror 402, such that the beam position (p_{cure}) is reversely symmetric with the reference beam position (p_{ref}).

Although the invention is illustrated and described herein with reference to specific embodiments, the invention is not intended to be limited to the details shown. Rather, various modifications may be made in the details within the scope and range of equivalents of the claims and without departing from the invention.

We claim:

1. A method of applying a precompensation for adhesive shrinkage during a real-time assembly of an optical component, the optical component being positionable away from a laser source and relative to a base by an alignment stage, the laser source being configured for providing a laser beam, the method comprising:
(a) aligning the optical component relative to a base based on a reference beam size (ω_{ref}) and a reference beam position (p_{ref}) to obtain a reference position (h_{ref}), which is determined by the alignment stage;
(b) plotting pre-assembly laser beam data reflected or transmitted by the optical component;
(c) aligning the optical component relative to the base in one or more misalignment positions (h), which is determined by the alignment stage, and repeating step (b) for each misalignment position (h), wherein at the respective one or more misalignment positions (h), the pre-assembly laser beam data comprises a respective beam size (ω) and a respective beam position (p); and
wherein steps (a) to (c) occur prior to the real-time assembly of the optical component;
(d) during a test event and the real-time assembly, applying an amount of curable adhesive to the base;
(e) during the test event and the real-time assembly, curing the adhesive;
(f) plotting test laser beam data reflected or transmitted by the optical component during the test event, wherein the test laser beam data comprises a beam size (ω_{cure}) and a beam position (p_{cure});
(g) determining a position of the optical component (h_{cure}) based on the pre-assembly laser beam data and the test laser beam data;
(h) calculating a precompensation value (δ=|h_{ref}−h_{cure}|, thereby estimating a linear shrinkage of the cured adhesive; and
(i) aligning the optical component relative to the base at a height (h=δ+h_{ref}=|h_{ref}−h_{cure}|+h_{ref}) before performing step (e) during the real-time assembly, thereby minimizing a misalignment of the optical component relative to the base during the real-time assembly.

2. The method of claim 1, wherein the pre-assembly laser beam data and test laser beam data are measured by a beam profiler, the beam profiler being disposed adjacent the optical component, such that the laser source, the optical component, and the beam profiler together define a laser beam path.

3. The method of claim 2, further comprising an imaging optics positionable along the laser beam path, the imaging optics disposed between the beam profiler and the optical component.

4. The method of claim 3, further comprising a beam attenuator configured for attenuating an intensity of the laser beam from the laser source.

5. The method of claim 4, wherein the optical component is a collimation lens.

6. The method of claim 5, wherein step (d) further comprises aligning the optical component to a height greater than the reference position (h_{ref}) and applying the adhesive to the base when the optical component is positioned at the height.

7. The method of claim 6, where step (e) further comprises aligning the optical component back to the reference position (h_{ref}) and the reference beam position (p_{ref}).

8. The method of claim 7, wherein the adhesive is cured when the optical component is at the reference position (h_{ref}) and the reference beam position (p_{ref}), and wherein the adhesive is cured with the laser source or an external radiation source, the laser source or the external radiation source comprising ultraviolet (UV) light.

9. The method of claim 8, wherein step (g) further comprises determining the position of the optical component (h_{cure}) based on a comparison of at least the reference position (h_{ref}) and the reference beam position (p_{ref}) with the position (h) and the beam position (p), respectively.

10. The method of claim 8, wherein step (i) comprises removing the optical component from the base and separating the cured adhesive from the base.

11. The method of claim 10, wherein step (h) comprises measuring a thickness T_{ad} of the cured adhesive, thereby estimating the linear shrinkage of the cured adhesive, which can be expressed as δ/(δ+T_{ad}).

12. The method of claim 11, further comprising a turning mirror configured to change a direction of the laser beam path.

13. The method of claim 12, wherein the turning mirror is positionable above the optical component and the laser beam path is changed from an upwardly direction to a lateral direction.

14. The method of claim 13, where step (e) further comprises aligning the optical component back to the reference position (h_{ref}) and the reference beam size (ω_{ref}).

15. The method of claim 14, wherein the adhesive is cured when the optical component is at the reference position (h_{ref}) and the reference beam size (ω_{ref}), and wherein the adhesive is cured with the laser source or an external radiation source, the laser source or the external radiation source comprising ultraviolet (UV) light.

16. The method of claim 15, wherein step (g) further comprises determining the position of the optical component (h_{cure}) based on a comparison of at least the reference position (h_{ref}) and the reference beam size (ω_{ref}) with the position (h) and the beam size (ω), respectively.

17. The method of claim 1, wherein the optical component is a reflection mirror disposed on the base and held by a gripper mounted on piezo motor mount, the mirror being configured for yaw and pitch movement.

18. The method of claim 17, further comprising a beam splitter configured to split a laser beam reflected by the mirror into a first path and a second path, and an aperture positioned between the laser source and the beam splitter, wherein the first path is transmitted through the beam splitter to the aperture and the second path is transmitted to the beam profiler.

19. The method of claim 18, wherein step (e) further comprises aligning the optical component back to the reference beam position (p_{ref}) by adjusting the pitch and yaw of the reflection mirror.

20. The method of claim 14, wherein step (g) further comprises adjusting the pitch and yaw of the reflection mirror, such that the beam position (p_{cure}) is reversely symmetric with the reference beam position (p_{ref}).

21. A system for assembling optical components, the system comprising:
an optical assembly comprising:
a laser source for providing a laser beam;
a base;
a gripper mounted on an alignment stage, the alignment stage being connected to a controller;
an optical component held by the gripper and positionable adjacent the base via the alignment stage; and
a beam profiler for measuring laser beam data at a position (h) of the optical component relative to the base, wherein the position (h) is measured by the alignment stage, and the laser beam data comprises a laser beam size (ω) and a laser beam position (p), and
wherein the laser source, the optical component, and the beam profiler together define a laser beam path; and
an adhesive assembly comprising:
a curable adhesive; and
an adhesive dispenser for applying the curable adhesive to the base.
